(19) United States
(12) Patent Application Publication
(10) Pub. No.: US 2005/0287862 A1
(43) Pub. Date: Dec. 29, 2005

(54) Quick wire connect angle plug

(76) Inventor: Cosmo Castaldo, Westbury, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 10/969,579

(22) Filed: Oct. 20, 2004

Related U.S. Application Data
(60) Provisional application No. 60/516,621, filed on Oct. 31, 2003.

(51) Int. Cl. H01R 4/24

(52) U.S. Cl. 439/409

(57) ABSTRACT

An electrical plug includes a first portion and a second portion that is matable with the first portion. The second portion has a channel for receiving a wire. The first portion includes at least one prong having a bifurcated contact. The bifurcated contact can pierce an insulation of the wire in the channel and can make contact with at least one conductor of the wire when the first portion is mated with the second portion. The bifurcated contacts are displaced longitudinally from one another along the length of the channel.

### CROSS REFERENCE TO RELATED APPLICATION

This application claims priority of U.S. provisional application Ser. No. 60/516,621, filed Jun. 22, 2004 and entitled “Wire Connect Angle Plug,” which is incorporated herein by reference in its entirety.

### BACKGROUND

A plug can be used for mating with a receptacle to transfer electrical power between two or more electrical components. Appliances for home and commercial use can have one or more wires that extend from the appliance and terminate in a plug at the opposite end of the wire. The plug can have conductive external blades that can be configured to seat into a receptacle outlet that can supply electrical power to the blades and then to the appliance through the wires. The wires may enter the plug either parallel to or at an angle to the blades. The wires may be electrically connected to the blades inside the plug in a variety of methods. One method of connection is by screw terminals where the wire can be positioned under a screw electrically connected to the blade and driving the screw with a screw driver. Soldering is another method of connection in which the wire is placed in electrical contact with the blade and a heating tool melts solder onto the connection. A mechanical connection between the wire and the blade can be made by, for example, by crimping a conductive sleeve with a crimping tool around both the conductor and a blade contact. Insulation displacement connection (IDC) is another way to make electrical contact between the wire and the blade. In an IDC, each blade is electrically connected to a piercing prong that pierces an insulation jacket surrounding a center conductor of each wire and electrically contacts the center conductor.

### SUMMARY OF THE DISCLOSURE

The method and apparatus of the present invention disclose an electrical plug having a first portion and a second portion matable with the first portion. The second portion can include a channel for receiving a wire therein. At least one prong is disposed within the first portion. The prong can have a bifurcated contact to pierce a received wire and make contact with at least one conductor of the received wire when the first portion is mated with the second portion.

In an implementation, the bifurcated contact pierces the received wire in two locations offset from one another longitudinally along a length of the channel. In some implementations, the first and second portions are secured together when the portions are mated. Some of the implementations of the disclosure may include one or more of the following advantages. The plug of the present invention is configured to allow a wire having one or more conductors of different types and/or sizes to be pierced without the need for user adjustment. The plug further has a one piece body with a living hinge and provides a method of trapping and positioning the wire to provide stress relief, all without the need for any secondary parts or tools.

### BRIEF DESCRIPTION OF THE DRAWINGS

FIG. 1 is a perspective of a plug in accordance with the present invention;

FIG. 2 is a perspective view of the plug of FIG. 1 in the open position prior to receiving a two wire conductor;

FIG. 3 is an enlarged view of the insulation piercing end of the contact blades positioned within the plug;

FIG. 4 is a perspective view of the plug of FIG. 1 in the open position including a two wire conductor; and

FIG. 5 shows the offset design of the piercing prongs engaging a two wire conductor.

### DETAILED DESCRIPTION

The plug of the present invention is configured to allow a wire having one or more conductors of different types and/or sizes to be pierced without the need for user adjustment. The connector has a first portion to receive the wire and is matable with a second portion. A piercing prong is disposed within the second portion of the connector. The piercing prong has bifurcated contacts that are positioned longitudinally along a length of the wire. As the two portions mated, the bifurcated contacts pierce an insulation of the wire and can make contact with a conductor therein.

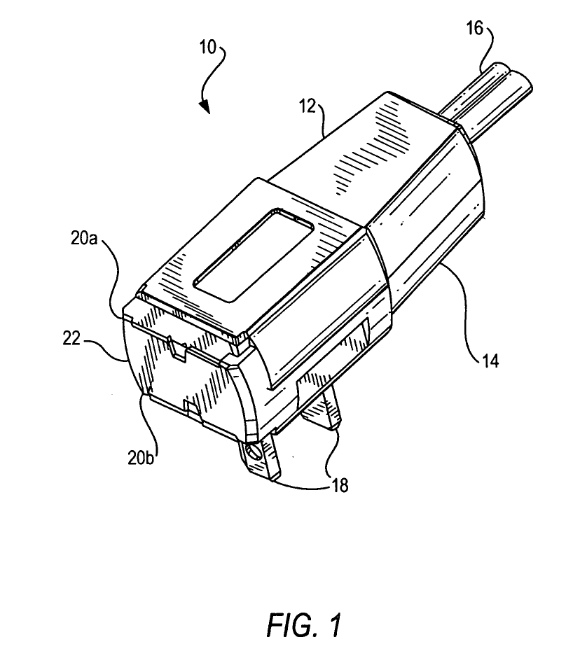

Referring to FIGS. 1-6, there is illustrated an embodiment of the plug of the present invention which includes a plug which can be connected to a two wire flat conductor of at least five different wire sizes without requiring any tools. The techniques and methods disclosed are not limited either with regard to the number of wires or the number of wires sizes that may be accommodated.

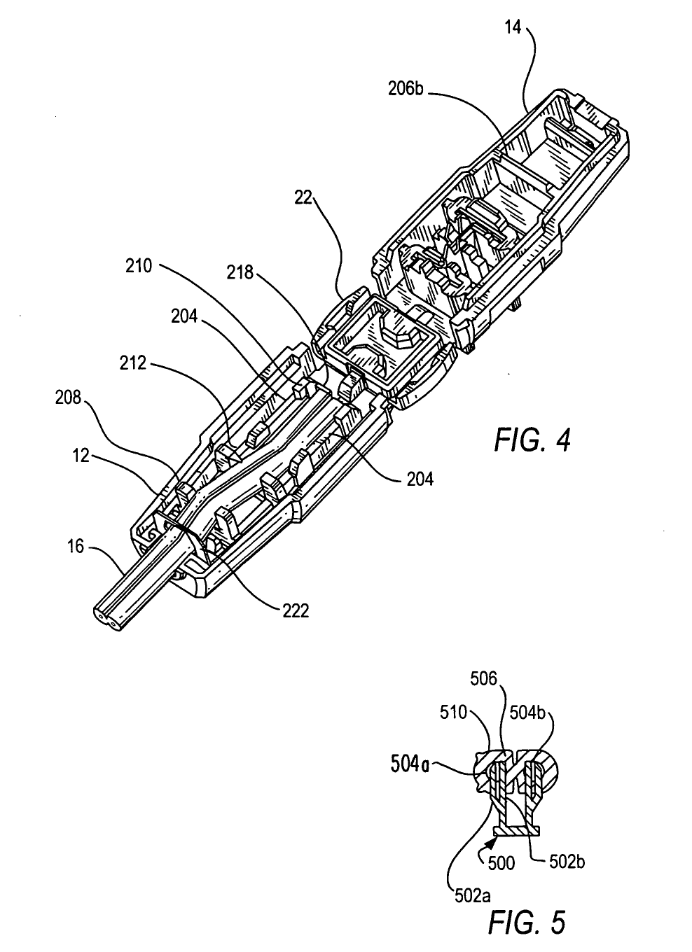

FIG. 1 illustrates an angle plug 10 version of the present invention. The plug includes a first portion 12 and a second portion 14, each of which is connected to a hinge 20a, 20b, respectively. The first and second portions are rotatably coupled to the hinges to allow the portions to mate with each other as shown in FIG. 1. A wire 16 such as from an appliance can be positioned in the plug 10. Internal piercing prongs in the plug (described below) can couple conductors within the wire to the blades 18. The wire 16 is positioned in the plug 10 when the plug is in its open state as shown in FIG. 4. When the second portion is rotated about hinge 20b, the piercing prongs can make electrical contact with a conductor in the wire 16 to electrically couple the conductor to the blades 18. At the same time, the wire 16 is captivated between the first and second portions 12, 14.

FIG. 5 illustrates implementation of piercing prongs 500. Each prong has bifurcated contacts 502a, 502b. When the prongs are impressed into a wire 510, the prongs pierce the insulation 506 and the contacts can come into electrical contact with the conductors 504a, 504b. The bifurcated contacts of the piercing prongs can be positioned in an offset configuration longitudinal to the conductor to insure proper wiring termination regardless of the size of the wire. Because of the offset of the contacts of the prongs, the device can accommodate a variation in the sizes of wire used in the plug. The contacts may be positioned anywhere along the expected cross-section of a conductor 504a, 504b. Offsetting of the contacts longitudinally with the wire can provide for placement of the contacts horizontally closer together than if the contacts were side by side.

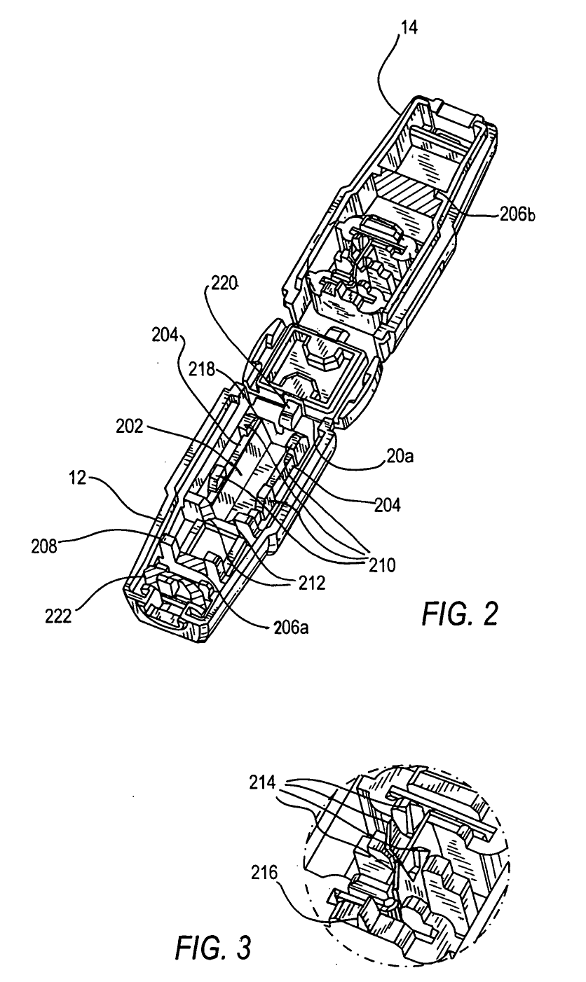

FIGS. 2-4 illustrate the internal arrangement of an implementation of an angle plug that may be assembled to an electrical cord without tools. Referring to FIG. 2, a series of main walls 204 perpendicular to a main wire channel 202 can be arranged to trap the wire 16 (see FIG. 4) in the channel 202. One or more stop ribs 218 can provide an end point of the wiring channel 202 and may provide both a limit on the length of wire in the plug and stability of the wire end. Guiding walls 208 may be arranged to offset laterally the wire from a longitudinal axis of the main wire channel 202. Guiding ribs 206a, 206b can be arranged to offset vertically the wire from the longitudinal axis of the wiring channel 202 and, when the connector is assembled, cause the wire 16 to be in serpentine configuration before entering the wiring channel 202. Referring to FIG. 4, one or more pairs of main locating ribs 210 can both crimp and center the wire in the wiring channel 202. A pair of secondary locating ribs 212 may be provided to crimp and center the wire 16 as it enters the channel 202. The main locating ribs 210 and secondary locating ribs 212 can provide strain relief and aid in the alignment of the wire 16 in the channel 202. The ribs (210, 212) can aid in aligning the wire with piercing prongs 214 (see FIG. 3) located at the ends of each of the plug blades. Some wires 16 may have a longitudinal groove in an insulation between conductors in the wire. A splitting rib 216 can be positioned in the plug to impinge in the groove between conductors of such wires 16 when the connector is assembled. Each blade 18 (see FIG. 1) of the plug can include two insulation piercing prongs 214, positioned to pierce the insulation around the conductor of wire 16 and make contact with the conductor within the wire. The piercing prongs 214 can be offset from one another so that multiple sizes of wire and the wire spacing between the two wires may be accurately terminated without the need for any user adjustments. Positioning of the bifurcated contacts along the length the wire can permit positioning of the contacts so at least one of the contacts will contact a conductor of the wire. An interlocking rib 220 may be located adjacent the hinge 20a and positioned to mate with a complementary counterpart (not shown) when the plug is assembled. A metal clip 222 can be mounted into either the first 12 or second 14 portion of the plug body and positioned to ride against a barb (not shown), which may be an integral part of the mating portion of the plug. When the plug is assembled, the clip 222 can hold the first and second portions together where the wire 16 enters the plug.

The plug may be used with wire 16 AWG wire having insulation types SPT-1 (service parallel thermoplastic), SPT-2 or HPN (heater parallel neoprene) two conductor, flat parallel cable of at least five different sizes including a #18 AWG SPT-1 and SPT-2, #16 AWG SPT-2, and a #18 or #16 AWG HPN. The wire can be pushed through an opening of the metal clip 222 and into the wiring channel 202 until the wire touches the stop rib 218. The guiding walls 202 and guiding rib 206 can cause the wire into a serpentine configuration when placed into the wiring channel and pull the wire inwards creating the slack needed for the main locating ribs 210 to act as a strain relief on the wire. The main locating ribs 210, 212 can prevent the wire from being pulled out of the plug. This may provide the strain relief of the wire 16 in the plug and can be an integral part of the housing. As the wire 16 is pushed down in the wiring channel 202 the main locating ribs 210 align the wire in the channel. A secondary locating rib 212 can help prevent the wire from slipping out of the wiring channel 202 and stop ribs 218 can help prevent the wire from sliding too far into the body of the plug. After the wire is inserted into the channel, the first and second portions are rotated about hinges 20a, 20b. The splitting rib 216 is positioned in the plug to enter into a center groove in the insulation of the wire between conductors. As the first and second portions 12, 14 are rotated about hinges 20a, 20b so one portion mates with the other, the splitting rib 216 can separate the two parts of the wire 16 to help prevents any stray strands from shorting out across the cable. As the plug is closed, the piercing prongs 214 may pierce the insulation of the wire 16 and make electrical contact with the conductor within the insulation. After the wire 16 is pushed through the opening of the metal clip 222, it is seated firmly in the wiring channel up against the ribs 210, 212. As the first and second portions 12, 14 of the plug are closed, the following operations are performed, substantially simultaneously: the mated first and second portions of the plug are held together with the clip 222 that springs inward at the top of a barb (NOT SHOWN) and holds the first and second portions in place.

Other embodiments are within the scope of the following claims.

1. An electrical plug comprising
a first portion;
a second portion matable with the first portion and having a channel for receiving a wire;
at least one prong disposed within the first portion and having a bifurcated contact to pierce a received wire and make contact with at least one conductor of the received wire when the first portion is mated with the second portion.

2. The electrical plug of claim 1 wherein the bifurcated contact pierces the received wire in two locations offset from one another longitudinally along a length of the channel.

3. The electrical plug of claim 2, wherein the first portion further comprises:
an end wall having an entry opening for receiving the wire, the wire having at least a first and a second conductor; and
a first and a second plurality of guiding ribs extending into the wiring channel,
wherein the first and second guiding ribs hold the wire in a desired position and retain the wire in the wiring channel.

4. The electrical plug of claim 3, wherein the second portion further comprises third and fourth ribs extending from an inner surface of the second portion, the third and fourth ribs complementary to the first and second ribs, respectively, of the first portion.

5. The electrical plug of claim 4, wherein the wire has at least a second conductor such that with the first and second body portions secured together, the first and second guiding ribs engage the third and fourth ribs, respectively, to secure the first conductor between the first and third ribs along a first path and the second conductor between the second and fourth ribs along a second path forming a strain relief combination of the first and second conductors by exerting a separate clamping force on the ends of each of the conductors.

6. The electrical plug of claim 2, comprising:
an assembly clip disposed at an end of the first portion,
wherein, an entry opening to the plug is formed when the first and second portions brought together,
wherein the assembly clip secures the wire at the entry opening and secures the first and second portions together.

7. A plug comprising:
a first portion;
a second portion matable and pivotally coupled to the first portion,
wherein the first portion comprises:
a wiring channel to receive a wire having one or more insulated conductors;
a first guiding rib positioned to engage the wire in the wiring channel and offset the wire in a vertical direction from the wiring channel;
a rib positioned to engage and secure the wire in the wiring channel from being pulled out of the channel when the first and second portions are mated together; and
a stop rib to restrict the length of the wire that can be inserted into the channel,
wherein the second portion comprises:
a second guiding rib to cause the wire into a serpentine configuration in a vertical direction with respect to the wiring channel when the first and second portions are pivoted together;
a splitting rib to separate ends of the conductors of the wire in the channel;
one or more electrically conductive blades,
one or more piercing prongs having a bifurcated contact, each piercing prong electrically coupled to an associated blade and wherein the contacts are offset from one another in a longitudinal direction of the wire channel.

8. A method of connecting a wire having one or more conductors to a plug, comprising:
pivotally connecting a first portion of the plug to a second portion of the plug, the second portion having a wire channel to receive the wire;
trapping the wire in the wire channel; and
mating the first and second portions to press down on the ends of the wire to force a piercing prong with bifurcated contacts offset longitudinally with respect to the wire channel to pierce an insulation of the wire and make contact with a conductor of the wire.

9. The method of claim 8, wherein trapping the wire includes forming the wire in a serpentine configuration and pulling the wire inwards to create strain relief in the wire.

10. The method of claim 8, comprising:
crimping and centering the wire in the wiring channel;
separating the conductors of the wire by cutting into a groove in an insulation between the conductors; and
securing the first and second portions of the plug together.
